(19) United States
(12) Patent Application Publication
(10) Pub. No.: US 2018/0191066 A1
(43) Pub. Date: Jul. 5, 2018

(54) BASE STATION ON SYSTEM-ON-CHIP

(71) Applicants: Andrey Orlov, Moscow (RU); Vasiliy Anisimov, Moscow (RU); Andrei Bakumenko, Lubertsi (RU); Andrey Puzanov, Dolgoprudny (RU); Alexey Danilov, Nizhny Novgorod (RU); Danylo Batura, Mytishchi (RU); Sergey Omelchenko, Moscow (RU)

(72) Inventors: Andrey Orlov, Moscow (RU); Vasiliy Anisimov, Moscow (RU); Andrei Bakumenko, Lubertsi (RU); Andrey Puzanov, Dolgoprudny (RU); Alexey Danilov, Nizhny Novgorod (RU); Danylo Batura, Mytishchi (RU); Sergey Omelchenko, Moscow (RU)

(21) Appl. No.: 15/858,769

(22) Filed: Dec. 29, 2017

Related U.S. Application Data
(60) Provisional application No. 62/440,926, filed on Dec. 30, 2016.

(51) Int. Cl. H01Q 5/307; H01Q 1/22; H01Q 23/00

(52) U.S. Cl. CPC H01Q 5/307; H01Q 23/00; H01Q 1/2283

(57) ABSTRACT

Base station for a wireless network for low-power low-speed high-range data transmission comprises a system-on-chip capable of receiving multiple simultaneous signals with at least two processor cores and ability to transmit signals.

### PRIORITY CLAIM/INCORPORATION BY REFERENCE

The present application claims priority to U.S. Provisional Patent Applications: 62/440,926 filed on Dec. 30, 2016 entitled “Base Station on System-on-Chip”; and hereby incorporates by reference, the entire subject matter of this Provisional Application.

### BACKGROUND INFORMATION

Many applications of Low Power Wide Area Networks (LPWAN) require small and power-efficient base stations. Existing base stations for narrowband low power networks are quite complex due to high unknown carrier frequency offset. Also, it is necessary to decode multiple simultaneous signals.

Mostly base stations for LPWAN networks are built using software of defined radio capabilities, usually based on FPGAs or large custom ASICs. Most base stations use software-defined digital signal processing blocks, or such blocks implemented as an ASIC. One of few system-on-chip-based base stations is LinkLabs LL-BST-8. It is a LoRa base station able to demodulate eight (8) channels.

### SUMMARY

Described is a base station comprising a system-on-chip with user core programmed to fulfill required duties for base station. Also, optional components like signal strength and signal to noise ratio measurement module and transmission frequency control module are required. Receiver design might be modified to include many more frequency shifts and initial time offsets than for normal operation

Furthermore, system-on-chip is connected to RX and TX antennas to receive radio frequency messages and is connected to a general-purpose computing device.

### DETAILED DESCRIPTION

The exemplary embodiment can be further understood with reference to the following description. The exemplary embodiment describes a base station to receive multiple narrowband signals with carrier frequency offset much larger than the signal bandwidth on a cost-effective and low power base station. The embodiment is much smaller and much more power-efficient than traditional LPWAN base stations. Its numerical capabilities are limited, but it is still able to receive tens of simultaneous messages. User core that is free from system tasks can be utilized for various base-station level tasks.

A base station includes a system-on-chip with two processor cores, and user core is programmed to implement required tasks. Also, the embodiment includes optional components like strength and signal to noise ratio measurement module and transmission frequency control. Receiver design may include many more frequency shifts and initial time offsets than for normal operation.

The base station can contain optional additional radio frequency components including but not limited to external amplifiers or external additional TX digital or analog circuitry. In case of multiple systems-on-chip, the embodiment can have additional analog or digital components for connection of these systems-on-chip. In addition, the base station contains antennas with one antenna is for receiving messages, and one or more antennas are for transmission.

The embodiment includes a general-purpose computing device for various tasks including but not limited to transmission of received messages, storing receiving messages and other tasks. Also, each system-on-chip is connected to a general-purpose computing device. If additional transmitting components are present, they are connected to any of Systems-on-Chip or to general-purpose computing device.

The system-on-chip is coupled to RX and TX antennas to receive and transmit radio frequency messages. In case of multiple systems-on-chip, multiple sets of antennas are required. In that case, additional digital processing components maybe used to connect these systems-on-chip to a single RX antenna and a single RT antenna.

What is claimed is:

1. A device comprising,
a system-on-chip including two processor cores wherein user core free from system tasks is programmed to implement required tasks.

2. The device according to claim 1 further comprises optional components including strength and signal to noise ration measurement module and transmission frequency control.

3. The device according to claim 1 further comprises antennas wherein one antenna is for receiving messages, and one or more antennas are for transmission.

4. The device according to claim 1 further comprises a general-purpose computing device to implement various tasks including transmission of received messages, storing received messages and other tasks.

5. The device according to claim 1 wherein each system-on-chip is coupled to a general-purpose computing device wherein additional transmitting components are coupled to any of systems-on-chip or to general purpose-computing device.

6. The device according to claim 1 wherein the system-on-chip is connected to RX and TX antennas to receive and transmit radio frequency messages wherein multiple systems-on-chip require multiple sets of antennas.
